(19) United States
(12) Patent Application Publication
(10) Pub. No.: US 2018/0251914 A1
(43) Pub. Date: Sep. 6, 2018

(54) POLYMIDE FIBER AND PREPARATION METHOD THEREOF

(71) Applicant: Changhun Institute of Applied Chemistry Chinese Academy of Science, Changchun City, Jilin Province (CN)

(72) Inventors: XUEPENG QIU, Changchun City, Jilin Province (CN); Xuemin DAI, Changchun City, Jilin Province (CN); Guomin LI, Changchun City, Jilin Province (CN); Zhixin DONG, Changchun City, Jilin Province (CN); Fangfang LIU, Changchun City, Jilin Province (CN); Xiangling JI, Changchun City, Jilin Province (CN); Lianxun GAO, Changchun City, Jilin Province (CN)

(73) Assignee: Changchun Institute of Applied Chemistry Chinese Academy of Sciences, Changchun City, Jilin Province (CN)

(21) Appl. No.: 15/571,448

(22) PCT Filed: Sep. 8, 2016
(86) PCT No.: PCT/CN2016/098433

§ 371 Date: Nov. 2, 2017

(30) Foreign Application Priority Data
Nov. 17, 2015 (CN) 201510790613.4

(51) Int. Cl. D01F 6/74; D01D 5/06; D01F 6/78

(52) U.S. Cl. CPC D01F 6/74; C08G 73/10; D01F 6/78; D01D 5/06

(57) ABSTRACT

This disclosure provides a polyimide fiber prepared from a dianhydride compound and a diamine compound, wherein said diamine compound is selected from one or more of the compounds represented by the following formulae (I), (II), (III) and (IV). A polyimide fiber is prepared by using a polyimide polymer system having a specific hydroxyl heterocyclic diamine copolymerization structure, and the prepared polyimide fiber has relatively high strength and modulus and is resistant to high temperature. Furthermore, the polyimide fiber prepared by this disclosure is provided with an active group on its surface, thus being easily adhered to various resin matrices, and the composite material prepared has good mechanical properties.

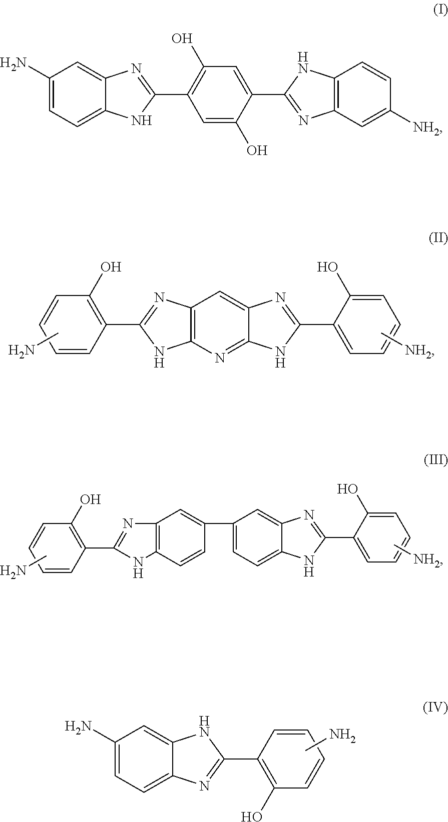

### CROSS REFERENCE TO RELATED APPLICATIONS

This application is a U.S. National Phase of PCT/CN2016/098433, filed Sep. 8, 2016, which claims priority to Chinese Application No. 201510790613.4, filed Nov. 17, 2015, the disclosures of which are incorporated herein by reference.

### TECHNICAL FIELD

This disclosure relates to the technical field of materials, and particularly to a polyimide fiber and a preparation method thereof.

### BACKGROUND ART

A polyimide fiber is one of high-performance fibers, and has a plurality of excellent properties, such as high strength, high modulus, good resistance to high temperature, good resistance to low temperature, good flame resistance, good resistance to chemical corrosion, good irradiation resistance, etc. It has been widely used in various fields, such as aerospace, national defense construction, ocean exploitation, sports equipment, protective tools, cables, nuclear industry, composite materials, fireproof and flame-retardant materials, etc.

Existing preparation methods for polyimide fibers include a one-step method and a two-step method. The one-step method refers to a method in which a polyimide solution is used to directly perform spinning, a fiber is preliminarily drawn to have certain strength, the solvent is removed, and thermal drawing and thermal treatment are performed. This method is advantageous in that imidization is not required for precursor fiber to be prepared, the process flow is short, and the polyimide fiber obtained has relatively high mechanical properties. This method for preparing a polyimide fiber has been disclosed in Chinese Patent No. ZL 02112048.X and US Patent Application Nos. U.S. Pat. No. 4,370,290 and U.S. Pat. No. 5,378,420. However, although the polyimide fiber prepared by the one-step method has properties of high strength and high modulus, it is disadvantageous for industrial applications due to the high toxicity of the solvent and the limit of the polymer structure.

The two-step method is a method in which diamine and dianhydride are first subjected to a polycondensation reaction to generate a polyamic acid solution, which is then spun to obtain a polyamic acid fiber, and the polyamic acid fiber is further subjected to processes of imidization, thermal drawing, and the like to finally obtain a polyimide fiber. This method for preparing a polyimide fiber has been disclosed in Japanese Patents JP03287815 and JP04018115 and Chinese Patent CN101338462B. This method is advantageous in that processability challenges caused by insolubility and infusibility of the polyimide are solved, there are many types of low-toxicity raw materials and solvents for synthesis, and the fiber has a low residue of solvents, and it is suitable for industrial production. However, although the two-step method solves difficulties in processability caused by insolubility and infusibility of the polyimide and the problem of the high toxicity of the solvent, the fiber prepared has relatively low mechanical properties.

### SUMMARY OF THE INVENTION

In view of this, the technical problem to be solved by this invention is to provide a polyimide fiber and a preparation method thereof. The polyimide fiber provided by this disclosure has good mechanical properties and is resistant to high temperature.

This disclosure provides a polyimide fiber prepared from a dianhydride compound and a diamine compound, wherein said diamine compound is selected from one or more of:

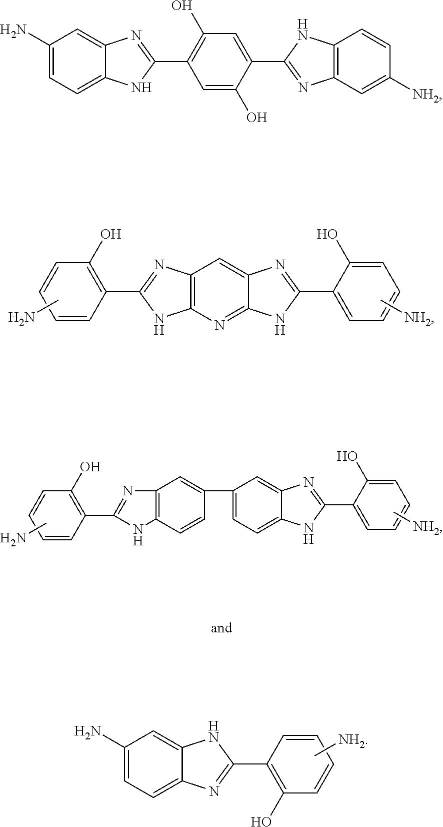

Preferably, said diamine compound further comprises one or more of:

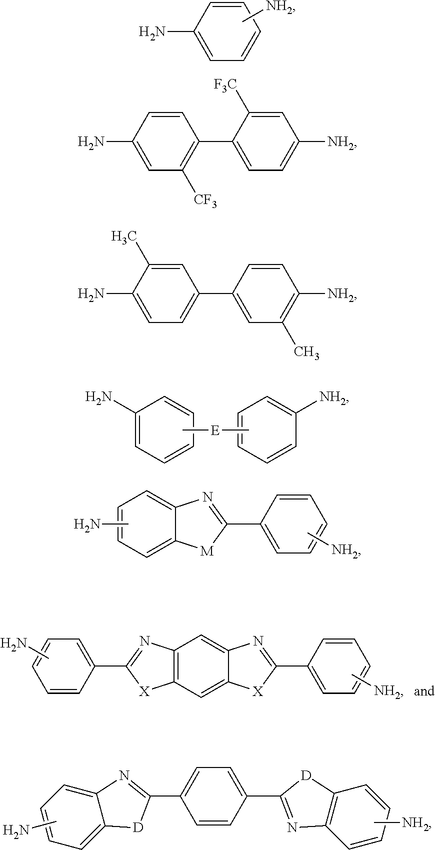

wherein -M- is selected from one or more of —O—, —S—, and —NH—; —X— is selected from one or more of —O—, —S—, and —NH—; -D- is selected from one or more of —O—, —S—, and —NH—; and E is selected from one or more of —O—, —S—, —SO₂—, —CH₂—, —C(CF₃)₂—, —CO—,

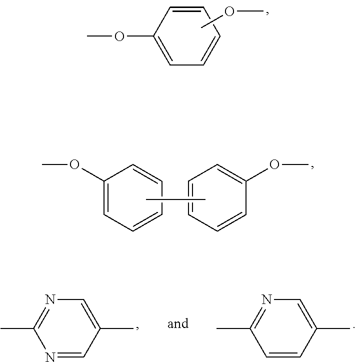

Preferably, said dianhydride compound is selected from one or more of:

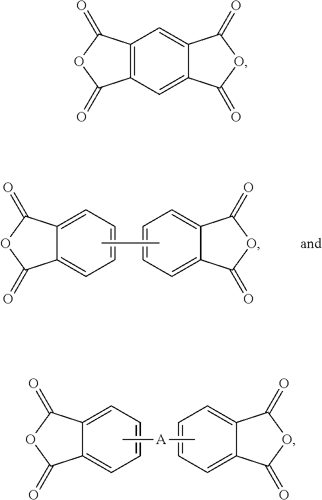

wherein said -A- is selected from —S—, —O—,

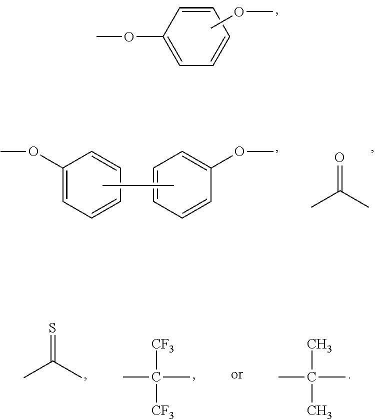

Preferably, the molar ratio of said dianhydride compound to said diamine compound is 1:(0.8-1.2).

This disclosure also provides a preparation method for a polyimide fiber, comprising the steps of:

A) subjecting a dianhydride compound and a diamine compound to a polymerization reaction to obtain a precursor polyamic acid solution; and

B) sequentially subjecting said precursor polyamic acid solution to spinning, imidization, and thermal drawing to obtain a polyimide fiber;

wherein said diamine compound is selected from one or more of:

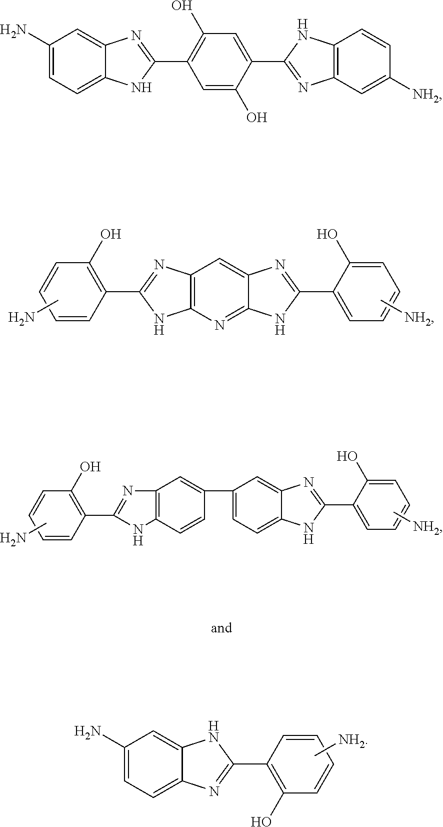

Preferably, said diamine compound further comprises one or more of:

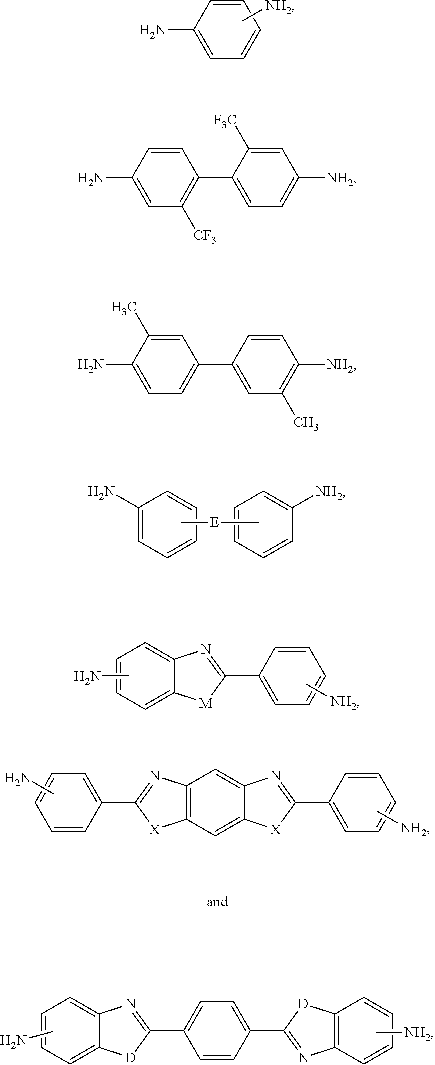

wherein -M- is selected from one or more of —O—, —S—, and —NH—; —X— is selected from one or more of —O—, —S—, and —NH—; -D- is selected from one or more of —O—, —S—, and —NH—; and E is selected from one or more of —O—, —S—, —SO₂—, —CH₂—, —C(CF₃)₂—, —CO—,

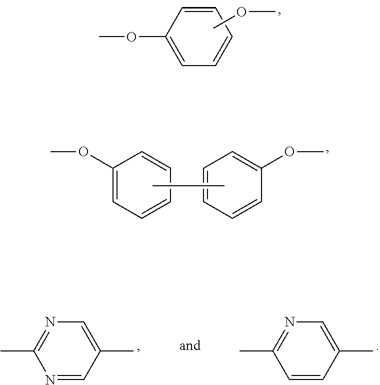

Preferably, said dianhydride compound is selected from one or more of:

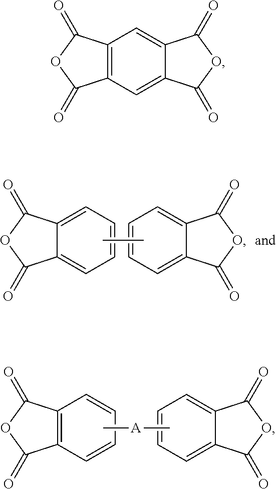

wherein said -A- is selected from —S—, —O—,

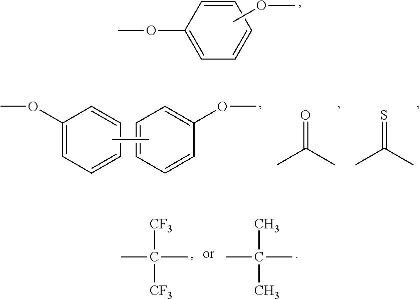

Preferably, the molar ratio of said dianhydride compound to said diamine compound is 1:(0.8-1.2).

Preferably, said spinning is wet spinning, wherein a spinneret for the wet spinning has an orifice size of Φ0.04-Φ0.4 mm and an orifice number of 10-10,000; a spinning draft ratio of the wet spinning is 1.1-6.0; and a speed of the wet spinning is 5-100 m/min.

Preferably, said spinning is dry-jet wet spinning, wherein a spinneret for the dry-jet wet spinning has an orifice size of Φ0.04-Φ0.4 mm and an orifice number of 10-10,000; a spinning draft ratio of the dry-jet wet spinning is 1.1-7.0; and a speed of the dry-jet wet spinning is 5-100 m/min.

Compared to the prior art, this disclosure provides a polyimide fiber prepared from a dianhydride compound and a diamine compound, wherein said diamine compound is selected from one or more of:

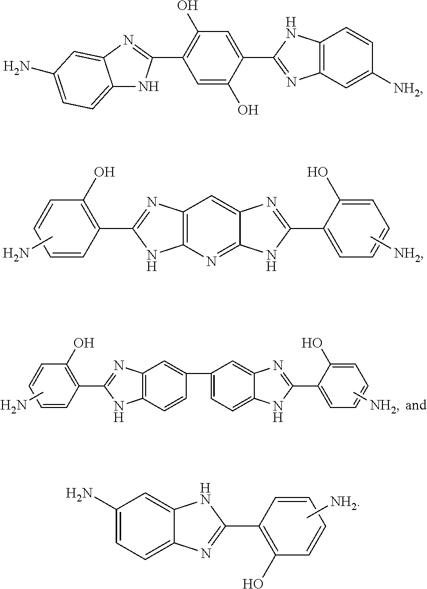

In this disclosure, a polyimide fiber is prepared by using a polyimide polymer system having a specific hydroxyl heterocyclic diamine copolymerization structure, and the prepared polyimide fiber has relatively high strength and modulus and is resistant to high temperature. Furthermore, the polyimide fiber prepared by this disclosure is provided with an active group on its surface, thus being easily adhered to various resin matrices, and the composite material prepared has good mechanical properties.

The results suggest that the polyimide fiber prepared by this disclosure has a strength of up to 5.1 GPa and a modulus up to 215.3 GPa. Under atmospheres of nitrogen and air, the polyimide fiber has 5 wt % thermal decomposition temperatures of 576° C. and 540° C. respectively and 10 wt % thermal decomposition temperatures of 595° C. and 567° C. respectively.

### DESCRIPTION OF DRAWINGS

FIG. 1 is an electron microscope scanning image of the polyimide fiber prepared in Example 1;

FIG. 2 is a FT-IR spectrum of the polyimide fiber prepared in Example 2;

FIG. 3 is a TGA plot of the polyimide fiber prepared in Example 5; and

FIG. 4 is a DMA plot of the polyimide fiber prepared in Example 6.

### DESCRIPTION OF EMBODIMENTS

This disclosure provides a polyimide fiber prepared from a dianhydride compound and a diamine compound, wherein said diamine compound is selected from one or more of:

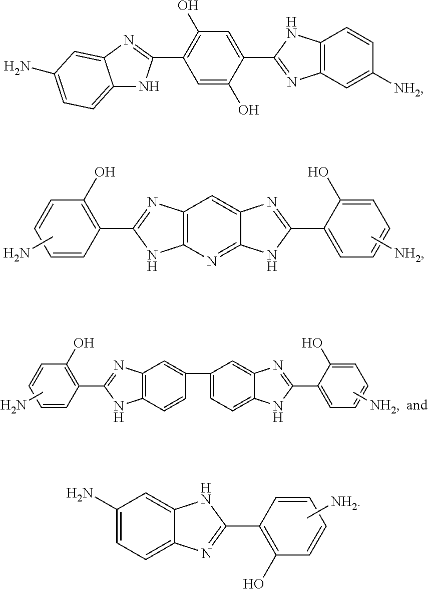

Preferably, said diamine compound may further comprise one or more of

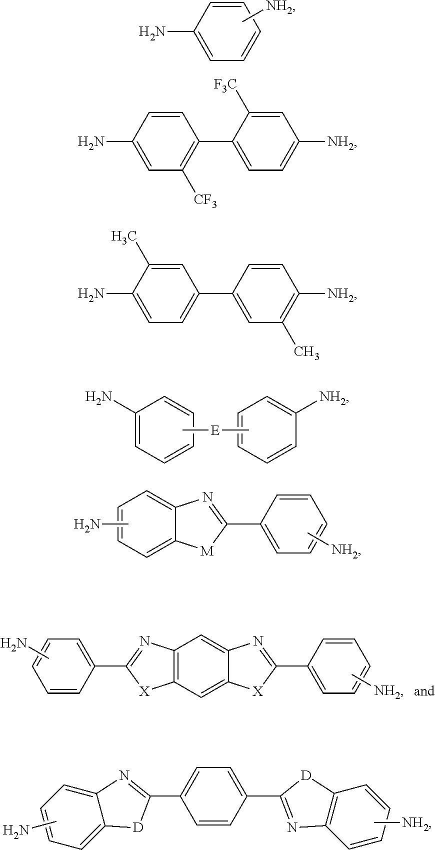

wherein -M- is selected from one or more of —O—, —S—, and —NH—; —X— is selected from one or more of —O—, —S—, and —NH—; -D- is selected from one or more of —O—, —S—, and —NH—; and E is selected from one or more of —O—, —S—, —SO₂—, —CH₂—, —C(CF₃)₂—, —CO—,

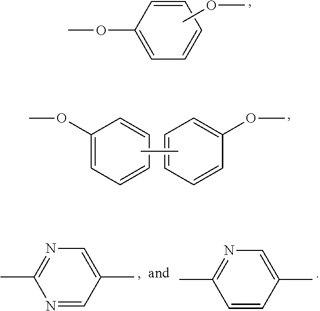

In some embodiments of this disclosure, said diamine compound is 2,2′-bis(2-hydroxyl-4-aminophenyl)-5,5′-bibenzo[1,2-d:1′,2′-d]diimidazole. In other embodiments of this disclosure, said diamine compound is 5-amino-2-(2-hydroxyl-4-aminophenyl)benzimidazole. In other embodiments of this disclosure, said diamine compound is 5-amino-2-(2-hydroxyl-5-aminophenyl)benzimidazole. In other embodiments of this disclosure, said diamine compound is 5-amino-2-(2′-hydroxyl-4′-aminophenyl)benzimidazole. In other embodiments of this disclosure, said diamine compound is mixed diamine compounds of 5-amino-2-(2′-hydroxyl-4′-aminophenyl)benzimidazole and 5-amino-2-(4-aminophenyl)benzimidazole. In other embodiments of this disclosure, said diamine compound is mixed diamine compounds of 2,6-di(2-hydroxyl-4-aminophenyl)pyrido[1,2-d:5,4-d]diimidazole and 4,4′-oxydianiline. In other embodiments of this disclosure, said diamine compound is 2,5-di(5′-amino-benzimidazol-2′-yl)-1,4-benzenediol. In other embodiments of this disclosure, said diamine compound is mixed diamines of 5-amino-2-(2-hydroxyl-5-aminophenyl)benzimidazole and p-phenylenediamine.

In this disclosure, said dianhydride compound is selected from one or more of:

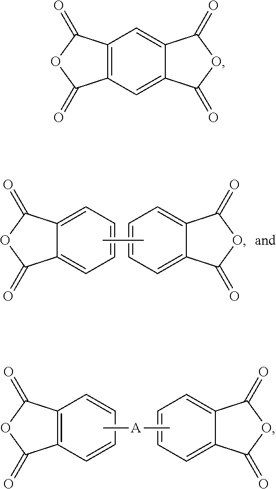

wherein said -A- is selected from —S—, —O—,

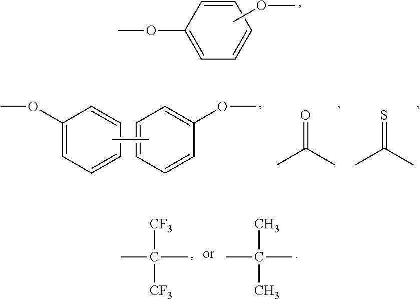

In some embodiments of this disclosure, said dianhydride compound is 4,4′-biphenyl dianhydride. In other embodiments of this disclosure, said dianhydride compound is pyromellitic dianhydride.

Preferably, the molar ratio of said dianhydride compound to said diamine compound is 1:(0.8-1.2), and more preferably 1:(0.9-1.1).

This disclosure also provides a preparation method for a polyimide fiber, comprising the steps of:

A) subjecting a dianhydride compound and a diamine compound to a polymerization reaction to obtain a precursor polyamic acid solution; and

B) sequentially subjecting said precursor polyamic acid solution to spinning, imidization, and thermal drawing to obtain a polyimide fiber.

In this disclosure, a dianhydride compound and a diamine compound are first subjected to a polymerization reaction to obtain a precursor polyamic acid solution.

Particularly, a dianhydride compound and a diamine compound are dissolved in a solvent, stirred, and subjected to a polymerization reaction to obtain a precursor polyamic acid solution. Here, the temperature of said polymerization reaction is in a range from −10° C. to 40° C., and the duration of said polymerization reaction is 1-40 h. The molar ratio of said dianhydride compound to said diamine compound is 1:(0.8-1.2), and more preferably 1:(0.9-1.1). Said solvent is preferably one or more of polar aprotic solvents, and more preferably one or more of N,N-dimethylformamide, N,N-dimethylacetamide, dimethyl sulfoxide, and N-methylpyrrolidone.

Said diamine compound is selected from one or more of:

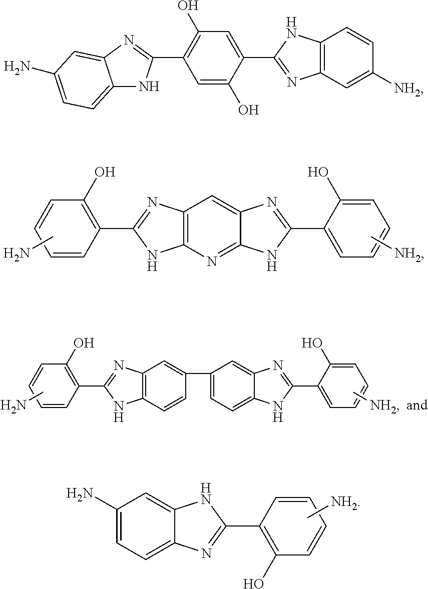

Preferably, said diamine compound may further comprise one or more of:

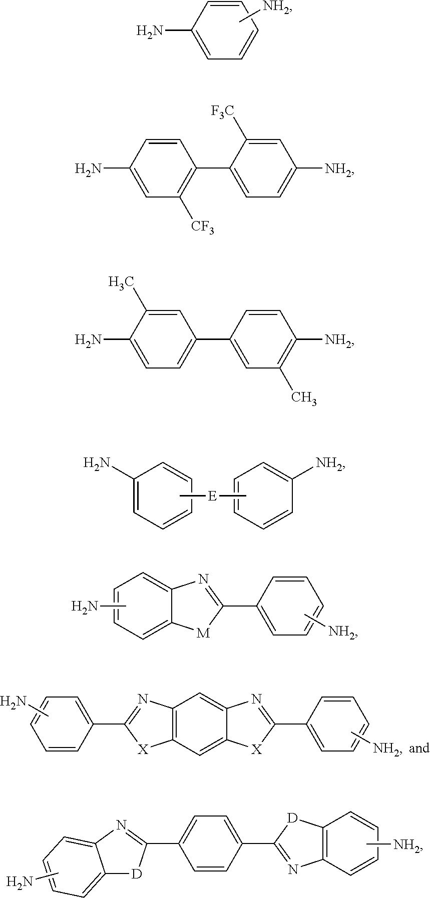

wherein -M- is selected from one or more of —O—, —S—, and —NH—; —X— is selected from one or more of —O—, —S—, and —NH—; -D- is selected from one or more of —O—, —S—, and —NH—; and E is selected from one or more of —O—, —S—, —SO₂—, —CH₂—, —C(CF₃)₂—, —CO—,

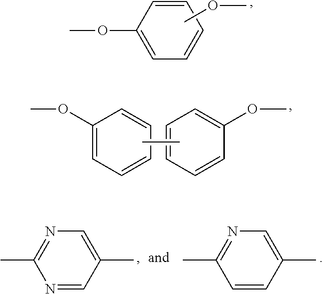

In some embodiments of this disclosure, said diamine compound is 2,2′-bis(2-hydroxyl-4-aminophenyl)-5,5′-bibenzo[1,2-d:1′,2′-d]diimidazole. In other embodiments of this disclosure, said diamine compound is 5-amino-2-(2-hydroxyl-4-aminophenyl)benzimidazole. In other embodiments of this disclosure, said diamine compound is 5-amino-2-(2-hydroxyl-5-aminophenyl)benzimidazole. In other embodiments of this disclosure, said diamine compound is 5-amino-2-(2′-hydroxyl-4′-aminophenyl)benzimidazole. In other embodiments of this disclosure, said diamine compound is mixed diamine compounds of 5-amino-2-(2′-hydroxyl-4′-aminophenyl)benzimidazole and 5-amino-2-(4-aminophenyl)benzimidazole. In other embodiments of this disclosure, said diamine compound is mixed diamine compounds of 2,6-di(2-hydroxyl-4-aminophenyl)pyrido[1,2-d:5,4-d]diimidazole and 4,4′-oxydianiline. In other embodiments of this disclosure, said diamine compound is 2,5-di(5′-amino-benzimidazol-2′-yl)-1,4-benzenediol. In other embodiments of this disclosure, said diamine compound is mixed diamines of 5-amino-2-(2-hydroxyl-5-aminophenyl)benzimidazole and p-phenylenediamine.

In this disclosure, said dianhydride compound is selected from one or more of:

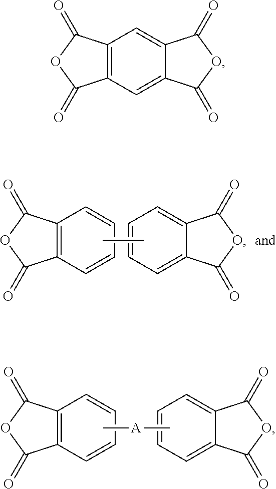

wherein said -A- is selected from —S—, —O—,

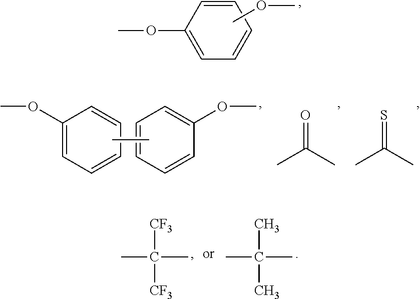

In some embodiments of this disclosure, said dianhydride compound is 4,4′-biphenyl dianhydride. In other embodiments of this disclosure, said dianhydride compound is pyromellitic dianhydride.

The concentration of said precursor polyamic acid solution finally obtained is preferably 5-35 wt %.

After the precursor polyamic acid solution is obtained, said precursor polyamic acid solution is sequentially subjected to spinning, imidization, and thermal drawing to obtain a polyimide fiber.

In this disclosure, said precursor polyamic acid solution is subjected to spinning to obtain a polyamic acid fiber. In this disclosure, said precursor polyamic acid solution is subjected to filtration and vacuum defoaming to obtain a spinning solution prior to spinning. In this disclosure, the methods for said filtration and vacuum defoaming are not particularly limited, as long as they are methods for filtration and vacuum defoaming well known to the person skilled in the art.

In this disclosure, the method for said spinning is preferably dry spinning, wet spinning, or dry-jet wet spinning. In this disclosure, the method for said spinning is not particularly limited, as long as it is a method for spinning well known to the person skilled in the art.

In this disclosure, said dry jet wet spinning is preferably performed according to the method as follows.

A precursor polyamic acid solution is extruded from a spinneret orifice through a metering pump, passed through a section of an air layer, passed into a coagulating bath to be molded, passed through a water washing tank, and dried through a hot roller or a hot gas channel to obtain a polyamic acid fiber.

The coagulating bath used is preferably a mixture of water and one of methanol, ethanol, ethylene glycol, butanol, acetone, and butanone, or a mixture of water and one or more of N,N-dimethylformamide, N,N-dimethylacetamide, dimethyl sulfoxide, and N-methylpyrrolidone. The atmosphere for said drying is preferably an inert gas, and more preferably air, nitrogen gas, or argon gas. The height of said air layer is preferably 3-100 mm, and more preferably 10-80 mm; said dry-jet wet spinning has a spinneret with an orifice size of preferably Φ0.04-Φ0.4 mm, and more preferably Φ0.08-Φ0.20 mm; the orifice number is preferably 10-10,000, and more preferably 50-1,000; said dry jet wet spinning has a spinning draft ratio of preferably 1.1-7.0, and more preferably 2-5; and said dry jet wet spinning has a speed of preferably 5-100 m/min, and more preferably 10-90 m/min.

In this disclosure, said wet spinning is preferably performed according to the method as follows.

A precursor polyamic acid solution is extruded from a spinneret orifice through a metering pump, directly passed into a coagulating bath to be molded, passed through a water washing tank, and dried through a hot roller or a hot gas channel.

The coagulating bath used is preferably a mixture of water and one of methanol, ethanol, ethylene glycol, butanol, acetone, and butanone, or a mixture of water and one or more of N,N-dimethylformamide, N,N-dimethylacetamide, dimethyl sulfoxide, and N-methylpyrrolidone. The atmosphere for said drying is preferably an inert gas, and more preferably air, nitrogen gas, or argon gas. Said wet spinning has a spinneret with an orifice size of preferably Φ0.04-Φ0.4 mm, and more preferably Φ0.05-Φ0.12 mm; said wet spinning has an orifice number of 10-10,000, and more preferably 100-8,000; said wet spinning has a spinning draft ratio of preferably 1.1-6.0, and more preferably 2-5; and said wet spinning has a speed of preferably 5-100 m/min, and more preferably 10-90 m/min.

In this disclosure, dry spinning may also be used to spin a polyimide fiber. When a method of dry spinning is used to spin a polyimide fiber, a precursor polyamic acid solution is extruded via a spinneret, then molded through a hot air channel, and elongated and thinned under the action of winding tension to form a primary fiber. The procedure and the method of drawing are the same as technical solutions of the two methods of spinning described above.

In this disclosure, after the polyamic acid fiber is obtained, said polyamic acid fiber is subjected to imidization to obtain a polyimide fiber precursor.

Here, in this disclosure, the particular method for said imidization of the polyamic acid fiber is not particularly limited, as long as it is a method for imidization well known to the person skilled in the art. In this disclosure, imidization is preferably performed by using a gradient heating thermal treatment furnace or a constant temperature thermal treatment furnace.

The temperature of said gradient heating thermal treatment is preferably 50-500° C., and the heating rate is preferably 1-30° C./min. The temperature of said constant temperature treatment is 300-500° C., and the treatment time is 5-60 min. The atmosphere for said imidization is preferably an inert gas, and more preferably air, nitrogen gas, or argon gas.

After the polyimide fiber precursor is obtained, said polyimide fiber precursor is subjected to thermal drawing to obtain a polyimide fiber. In this disclosure, the method for said thermal drawing is not particularly limited, as long as it is a method for thermal drawing well known to the person skilled in the art. In this disclosure, the temperature of said thermal drawing is preferably 350-570° C., and more preferably 400-550° C.; and the ratio of said thermal drawing is preferably 1.0-6.0, and more preferably 2-5. The atmosphere for said thermal drawing is preferably an inert gas, and more preferably air, nitrogen gas, or argon gas.

In this disclosure, a polyimide fiber is prepared by using a polyimide polymer system having a specific hydroxyl heterocyclic diamine copolymerization structure, and the prepared polyimide fiber has relatively high strength and modulus and is resistant to high temperature. Furthermore, the polyimide fiber prepared by this disclosure is provided with an active group on its surface, thus being easily adhered to various resin matrices, and the composite material prepared has good mechanical properties.

The results indicate that the polyimide fiber prepared by this disclosure has a strength of up to 5.1 GPa and a modulus up to 215.3 GPa. Under atmospheres of nitrogen and air, the polyimide fiber has 5 wt % thermal decomposition temperatures of 576° C. and 540° C. respectively and 10 wt % thermal decomposition temperatures of 595° C. and 567° C. respectively.

For further understanding of this invention, the polyimide fiber and the preparation method thereof provided by this disclosure are described in detail below in conjunction with Examples. The protection scope of this invention is not limited by the following Examples.

### Example 1

448.49 g (1.0 mol) of 2,2′-bis(2-hydroxyl-4-aminophenyl)-5,5′-bibenzo[1,2-d:1′,2′-d′]diimidazole was dissolved in 3,800 ml of N,N-dimethylformamide, 294.22 g (1.0 mol) of 4,4′-biphenyl dianhydride was added with stirring, and reaction was performed at −10° C. for 24 hours to obtain a light yellow viscous polyamic acid spinning solution, which was directly used as a spinning slurry after filtration.

The polyamic acid slurry described above was spun and molded by using a technical scheme of dry-jet wet spinning, and the spinning slurry at normal temperature was precisely metered with a metering pump, extruded from a spinneret orifice, passed through an air layer, and then passed into a coagulating bath of N,N-dimethylformamide and water (the volume ratio of N,N-dimethylformamide to water was 1:5). The spinneret had 100 orifices, the orifice size was Φ0.18 mm, the spinning draft ratio was 3.2, the spinning speed was 50 m/min, and the height of the air layer was 12 mm. The primary fiber was washed with water and then dried through a hot nitrogen gas channel to obtain a polyamic acid fiber.

The polyamic acid fiber was treated with a gradient heating thermal imidization furnace under an atmosphere of nitrogen gas to obtain a polyimide fiber. The temperature of the thermal imidization was increased from 50° C. to 450° C. at a heating rate of 5° C./min. Next, the polyimide fiber obtained was drawn at a drawing ratio of 1.3 under an atmosphere of nitrogen gas at 500° C. to obtain a finished polyimide fiber.

The finished polyimide fiber which was 20 mm and had a modulus of 0.2-0.4% deformation was tested for properties 10 times by using a FAVIMAT tester for linear density, degree of crimp, and tensile strength of single fiber available from Textechno Corporation, Germany, and average values were employed. As a result, the fiber had a breaking strength of 4.0 GPa, a modulus of 155 GPa, and an elongation at break of 2.1%.

The polyimide fiber provided by this disclosure was subjected to electron microscope scanning, and the results can be seen in FIG. 1. FIG. 1 was an electron microscope scanning image of the polyimide fiber prepared in Example 1.

The molecular structural formula of the polyimide fiber in this Example was as follow:

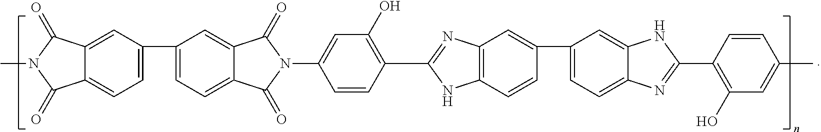

### Example 2

240.27 g (1.0 mol) of 5-amino-2-(2-hydroxyl-4-aminophenyl)benzimidazole was dissolved in 3,700 ml of N,N-dimethylacetamide, 294.22 g (1.0 mol) of 4,4′-biphenyl dianhydride was added with stirring, and reaction was performed at 30° C. for 24 hours to obtain a light yellow viscous polyamic acid spinning solution, which was directly used as a spinning slurry after filtration.

The polyamic acid slurry described above was spun and molded by using a technical scheme of dry-jet wet spinning, and the spinning slurry at normal temperature was precisely metered with a metering pump, extruded from a spinneret orifice, passed through an air layer, and then passed into a coagulating bath of N,N-dimethylacetamide and water (the volume ratio of N,N-dimethylacetamide to water was 1:2). The spinneret had 200 orifices, the orifice size was Φ0.18 mm, the spinning draft ratio was 3.8, the spinning speed was 60 m/min, and the height of the air layer was 15 mm. The primary fiber was washed with water and dried through a hot nitrogen gas channel to obtain a polyamic acid fiber.

The polyamic acid fiber was treated with a gradient heating thermal imidization furnace under an atmosphere of nitrogen gas to obtain a polyimide fiber. The temperature of thermal imidization was increased from 50° C. to 400° C. at a heating rate of 10° C./min. The polyimide fiber obtained was drawn at a drawing ratio of 1.3 under an atmosphere of nitrogen gas at 480° C. to obtain a finished polyimide fiber.

The finished polyimide fiber which was 20 mm and had a modulus of 0.2-0.4% deformation was tested for properties 10 times by using a FAVIMAT tester for linear density, degree of crimp, and tensile strength of single fiber available from Textechno Corporation, Germany, and average values were employed. As a result, the fiber had a breaking strength of 3.6 GPa, a modulus of 118.2 GPa, and an elongation at break of 2.8%.

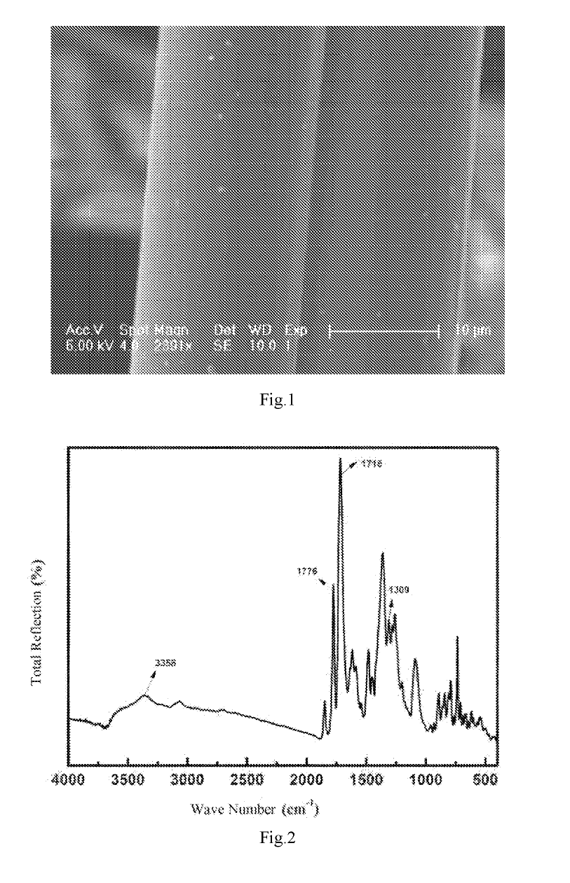

The polyimide fiber prepared in Example 2 was subjected to Fourier transform infrared spectroscopic analysis, and the results can be seen in FIG. 2. FIG. 2 was a FT-IR spectrum of the polyimide fiber prepared in Example 2. In FIG. 2, 1776 cm⁻¹ was attributed to the symmetrical stretching vibration of a carbonyl group in an imine ring, 1718 cm⁻¹ was attributed to the asymmetric stretching vibration of a carbonyl group in an imine ring, 1309 cm⁻¹ was attributed to the stretching vibration of a benzimidazole ring, and 3358 cm⁻¹ was attributed to the stretching vibration of N—H in a benzimidazole ring. The result indicated that the polyimide fiber was successfully prepared in Example 2.

The molecular structural formula of the polyimide fiber in this Example was as follow:

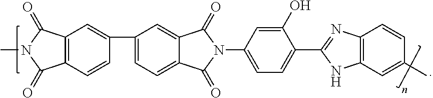

### Example 3

240.27 g (1.0 mol) of 5-amino-2-(2-hydroxyl-5-aminophenyl)benzimidazole was dissolved in 3,500 ml of N,N-dimethylformamide, 294.22 g (1.0 mol) of 4,4′-biphenyl dianhydride was added with stirring, and reaction was performed at 30° C. for 36 hours to obtain a light yellow viscous polyamic acid spinning solution, which was directly used as a spinning slurry after filtration.

The polyamic acid slurry described above was spun and molded by using a technical scheme of dry-jet wet spinning, and the spinning slurry at normal temperature was precisely metered with a metering pump, extruded from a spinneret orifice, passed through an air layer, and then passed into a coagulating bath of N,N-dimethylformamide and water (the volume ratio of N,N-dimethylformamide to water was 1:3.5). The spinneret had 200 orifices, the orifice size was Φ0.15 mm, the spinning draft ratio was 4.0, the spinning speed was 50 m/min, and the height of the air layer was 10 mm. The primary fiber was washed with water and dried through a hot nitrogen gas channel to obtain a polyamic acid fiber.

The polyamic acid fiber was treated with a gradient heating thermal imidization furnace under an atmosphere of nitrogen gas to obtain a polyimide fiber. The temperature of thermal imidization was increased from 50° C. to 400° C. at a heating rate of 5° C./min. The polyimide fiber obtained was drawn at a drawing ratio of 1.8 under an atmosphere of nitrogen gas at 500° C. to obtain a finished polyimide fiber.

The finished polyimide fiber which was 20 mm and had a modulus of 0.2-0.4% deformation was tested for properties 10 times by using a FAVIMAT tester for linear density, degree of crimp, and tensile strength of single fiber available from Textechno Corporation, Germany, and average values were employed. As a result, the fiber had a breaking strength of 3.62 GPa, a modulus of 110.8 GPa, and an elongation at break of 3.2%.

The molecular structural formula of the polyimide fiber in this Example was as follow:

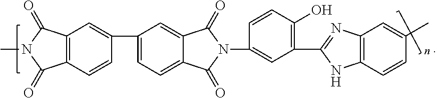

### Example 4

180.20 g (0.750 mol) of 5-amino-2-(2′-hydroxyl-4′-aminophenyl)benzimidazole and 168.20 g (0.750 mol) of 5-amino-2-(4-aminophenyl)benzimidazole were dissolved in 4,000 ml of N-methylpyrrolidone, 308.93 g (1.05 mol) of 4,4′-biphenyl dianhydride was added with stirring, and reaction was performed at room temperature for 24 hours to obtain a light yellow viscous polyamic acid spinning solution, which was directly used as a spinning slurry after filtration.

The polyamic acid slurry described above was spun and molded by using dry jet wet spinning, and the spinning slurry at normal temperature was precisely metered with a metering pump, extruded from a spinneret orifice, passed through an air layer, and then passed into a coagulating bath of N-methylpyrrolidone and water (in a volume ratio of 1:4). Here, the spinneret had 100 orifices, the orifice size was Φ0.08 mm, the spinning draft ratio was 3.0, the spinning speed was 50 m/min, and the height of the air layer was 15 mm. The primary fiber was washed with water and dried through a hot roller to obtain a polyamic acid fiber.

The polyamic acid fiber was treated with a gradient heating thermal imidization furnace under an atmosphere of nitrogen gas to obtain a primary polyimide fiber. The temperature of thermal imidization was increased from 50° C. to 500° C. at a heating rate of 10° C./min. The primary polyimide fiber was drawn at a drawing ratio of 2.1 under an atmosphere of nitrogen gas at 500° C. to obtain a finished polyimide fiber.

The finished polyimide fiber which was 20 mm and had a modulus of 0.2-0.4% deformation was tested for properties 10 times by using a FAVIMAT tester for linear density, degree of crimp, and tensile strength of single fiber available from Textechno Corporation, Germany, and average values were employed. As a result, the fiber had a breaking strength of 5.10 GPa, a modulus of 215.3 GPa, and an elongation at break of 2.2%.

The molecular structural formula of the polyimide fiber in this Example was as follow:

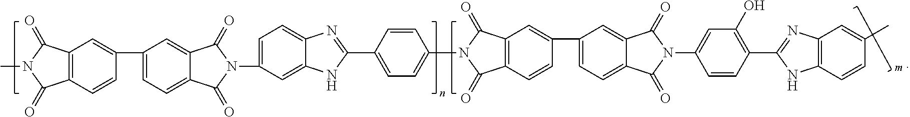

### Example 5

360.41 g (1.5 mol) of 5-amino-2-(2-hydroxyl-5-aminophenyl)benzimidazole was dissolved in 4,500 ml of N,N-dimethylacetamide, 163.66 g (0.75 mol) of pyromellitic dianhydride and 220.67 g (0.75 mol) of 4,4′-biphenyl dianhydride were added with stirring, and reaction was performed at −10° C. for 24 hours to obtain a light yellow viscous polyamic acid spinning solution, which was directly used as a spinning slurry after filtration.

The polyamic acid slurry described above was spun and molded by using a technical scheme of wet spinning, and the spinning slurry at normal temperature was precisely metered with a metering pump, extruded from a spinneret orifice, and then directly passed into a coagulating bath of N,N-dimethylacetamide and water (in a volume ratio of 1:5). The spinneret had 200 orifices, the orifice size was Φ0.15 mm, the spinning draft ratio was 3.6, and the spinning speed was 65 m/min. The primary fiber was washed with water and dried through a hot nitrogen gas channel to obtain a polyamic acid fiber.

The polyamic acid fiber was treated with a gradient heating thermal imidization furnace under an atmosphere of nitrogen gas to obtain a polyimide fiber. The temperature of thermal imidization was increased from 50° C. to 450° C. at a heating rate of 5° C./min. The polyimide fiber obtained was drawn at a drawing ratio of 1.3 under an atmosphere of nitrogen gas at 520° C. to obtain a finished polyimide fiber.

The finished polyimide fiber which was 20 mm and had a modulus of 0.2-0.4% deformation was tested for properties 10 times by using a FAVIMAT tester for linear density, degree of crimp, and tensile strength of single fiber available from Textechno Corporation, Germany, and average values were employed. As a result, the fiber had a breaking strength of 4.6 GPa, a modulus of 211.5 GPa, and an elongation at break of 2.1%.

The thermal decomposition property of the polyimide fiber described above was measured, and the results can be seen in FIG. 3. FIG. 3 is a TGA plot of the polyimide fiber prepared in Example 5. The results indicated that under atmospheres of nitrogen and air, the polyimide fiber prepared in Example 5 had 5 wt % thermal decomposition temperatures of 576° C. and 540° C. respectively and 10 wt % thermal decomposition temperatures of 595° C. and 567° C. respectively.

The molecular structural formula of the polyimide fiber in this Example was as follow:

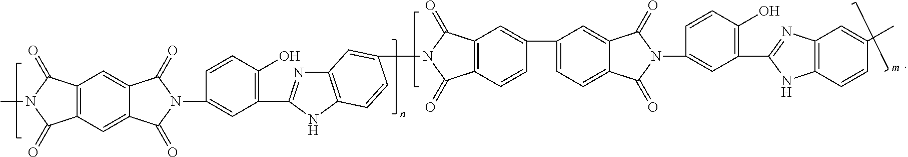

### Example 6

180.20 g (0.750 mol) of 5-amino-2-(2-hydroxyl-4-aminophenyl)benzimidazole and 150.18 g (0.750 mol) of 4,4′-oxydianiline were dissolved in 3,500 ml of N,N-dimethylformamide, 441.34 g (1.50 mol) of 4,4′-biphenyl dianhydride was added with stirring, and reaction was performed at room temperature for 10 hours to obtain a light yellow viscous polyamic acid spinning solution, which was directly used as a spinning slurry after filtration.

The polyamic acid slurry described above was spun and molded by using a technical scheme of dry-jet wet spinning, and the spinning slurry at normal temperature was precisely metered with a metering pump, extruded from a spinneret orifice, passed through an air layer, and then passed into a coagulating bath of N,N-dimethylformamide and water (in a volume ratio of 1:3.2). The spinneret had 100 orifices, the orifice size was Φ0.18 mm, the spinning draft ratio was 3.8, the spinning speed was 30 m/min, and the height of the air layer was 10 mm. The primary fiber was washed with water and dried through a hot nitrogen gas channel to obtain a polyamic acid fiber.

The polyamic acid fiber was treated with a gradient heating thermal imidization furnace under an atmosphere of nitrogen gas to obtain a polyimide fiber. The temperature of thermal imidization was increased from 50° C. to 400° C. at a heating rate of 5° C./min. The polyimide fiber obtained was drawn at a drawing ratio of 2.8 under an atmosphere of nitrogen gas at 510° C. to obtain a finished polyimide fiber.

The finished polyimide fiber which was 20 mm and had a modulus of 0.2-0.4% deformation was tested for properties 10 times by using a FAVIMAT tester for linear density, degree of crimp, and tensile strength of single fiber available from Textechno Corporation, Germany, and average values were employed. As a result, the fiber had a breaking strength of 3.3 GPa, a modulus of 113.1 GPa, and an elongation at break of 2.8%.

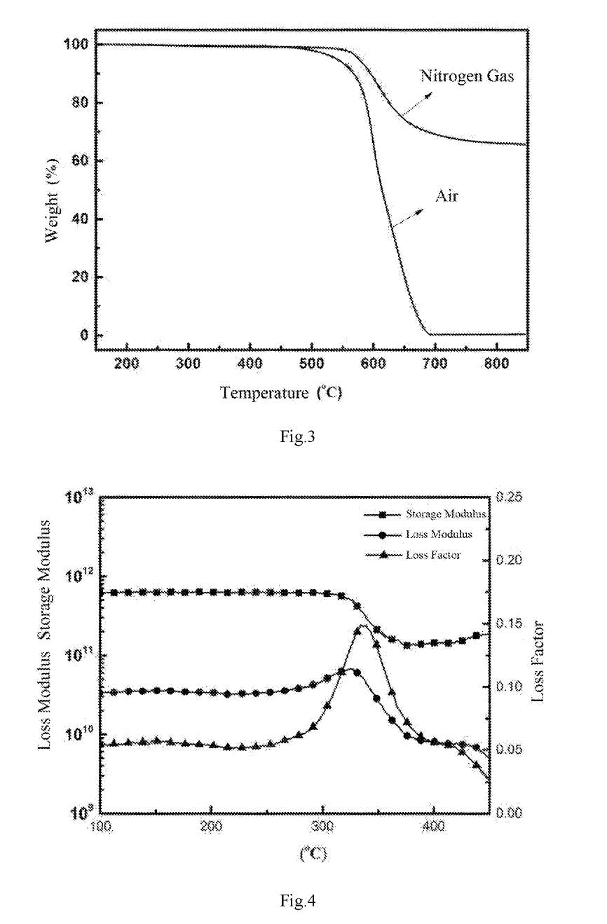

The glass transition temperature of the polyimide fiber described above was measured, and the results can be seen in FIG. 4. FIG. 4 is a DMA plot of the polyimide fiber prepared in Example 6. It can be seen from the tan δ plot that the glass transition temperature of the polyimide fiber in Example 6 was 338° C.

The molecular structural formula of the polyimide fiber in this Example was as follow:

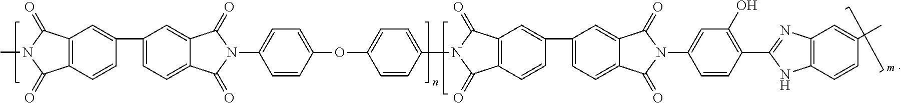

### Example 7

180.20 g (0.750 mol) of 5-amino-2-(2-hydroxyl-4-aminophenyl)benzimidazole and 180.22 g (0.750 mol) of 5-amino-2-(2-hydroxyl-5-aminophenyl)benzimidazole was dissolved in 5,000 ml of N,N-dimethylacetamide, 441.34 g (1.50 mol) of 4,4′-biphenyl dianhydride was added with stirring, and reaction was performed at room temperature for 24 hours to obtain a light yellow viscous polyamic acid spinning solution, which was directly used as a spinning slurry after filtration.

The polyamic acid slurry described above was spun and molded by using a technical scheme of dry-jet wet spinning, and the spinning slurry at normal temperature was precisely metered with a metering pump, extruded from a spinneret orifice, passed through an air layer, and then passed into a coagulating bath of N,N-dimethylacetamide and water (in a volume ratio of 1:3.3). The spinneret had 200 orifices, the orifice size was Φ0.12 mm, the spinning draft ratio was 3.6, the spinning speed was 50 m/min, and the height of the air layer was 10 mm. The primary fiber was washed with water and dried through a hot nitrogen gas channel to obtain a polyamic acid fiber.

The polyamic acid fiber was treated with a gradient heating thermal imidization furnace under an atmosphere of nitrogen gas to obtain a polyimide fiber. The temperature of thermal imidization was increased from 50° C. to 400° C. at a heating rate of 10° C./min. The polyimide fiber obtained was drawn at a drawing ratio of 2.2 under an atmosphere of nitrogen gas at 490° C. to obtain a finished polyimide fiber.

The finished polyimide fiber which was 20 mm and had a modulus of 0.2-0.4% deformation was tested for properties 10 times by using a FAVIMAT tester for linear density, degree of crimp, and tensile strength of single fiber available from Textechno Corporation, Germany, and average values were employed. As a result, the fiber had a breaking strength of 4.1 GPa, a modulus of 152.6 GPa, and an elongation at break of 2.1%.

The molecular structural formula of the polyimide fiber in this Example was as follow:

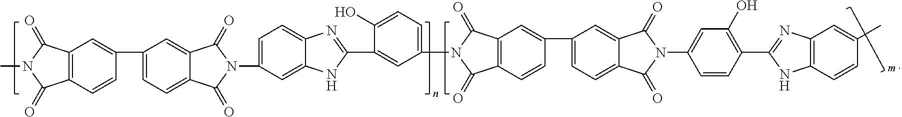

### Example 8

186.69 g (0.50 mol) of 2,6-di(2-hydroxyl-4-aminophenyl)pyrido[1,2-d:5,4-d′]diimidazole and 100.12 g (0.50 mol) of 4,4′-oxydianiline were dissolved in 4,300 ml of N-methylpyrrolidone, 294.22 g (1.0 mol) of 4,4′-biphenyl dianhydride was added with stirring, and reaction was performed at room temperature for 24 hours to obtain a reddish brown viscous polyamic acid spinning solution, which was directly used as a spinning slurry after filtration.

The polyamic acid slurry described above was spun and molded by using wet spinning, and the spinning slurry at normal temperature was precisely metered with a metering pump, extruded from a spinneret orifice, and then passed into a coagulating bath of N-methylpyrrolidone and water (in a volume ratio of 1:2.5). The spinneret had 500 orifices, the orifice size was Φ0.18 mm, the spinning draft ratio was 3.2, and the speed was 50 m/min. The primary fiber was washed with water and dried through a hot air channel to obtain a polyamic acid fiber.

The polyamic acid fiber was treated with a gradient heating thermal imidization furnace under an atmosphere of air to obtain a polyimide fiber. The temperature of thermal imidization was increased from 50° C. to 400° C. at a heating rate of 10° C./min. The polyimide fiber obtained was drawn at a drawing ratio of 2.0 under an atmosphere of air at 520° C. to obtain a finished polyimide fiber. The fiber had a breaking strength of 4.7 GPa, a modulus of 212.4 GPa, and an elongation at break of 1.8%.

The molecular structural formula of the polyimide fiber in this Example was as follow:

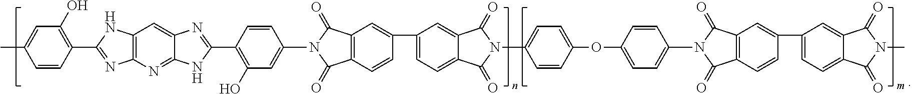

### Example 9

558.59 g (1.5 mol) of 2,5-di(5′-amino-benzimidazol-2′-yl)-1,4-benzenediol was dissolved in 5,300 ml of N,N-dimethylacetamide, 220.67 g (0.75 mol) of 4,4′-biphenyl dianhydride and 163.67 g (0.75 mol) of pyromellitic dianhydride were added with stirring, and reaction was performed at 20° C. for 12 hours to obtain a light yellow viscous polyamic acid spinning solution, which was directly used as a spinning slurry after filtration.

The polyamic acid slurry described above was spun and molded by using dry jet wet spinning, and the spinning slurry at normal temperature was precisely metered with a metering pump, extruded from a spinneret orifice, passed through an air layer, and then passed into a coagulating bath of N,N-dimethylacetamide and water (in a volume ratio of 1:6). The spinneret had 200 orifices, the orifice size was Φ0.15 mm, the spinning speed was 40 m/min, the spinning draft ratio was 2.80, and the height of the air layer was 20 mm. The primary fiber was washed with water and dried through a hot roller to obtain a polyamic acid fiber.

The polyamic acid fiber was treated with a gradient heating thermal imidization furnace under an atmosphere of nitrogen gas to obtain a polyimide fiber. The temperature of thermal imidization was increased from 50° C. to 500° C. at a heating rate of 10° C./min. The polyimide fiber obtained was drawn at a drawing ratio of 1.5 under an atmosphere of nitrogen gas at 530° C. to obtain a finished polyimide fiber.

The finished polyimide fiber which was 20 mm and had a modulus of 0.2-0.4% deformation was tested for properties 10 times by using a FAVIMAT tester for linear density, degree of crimp, and tensile strength of single fiber available from Textechno Corporation, Germany, and average values were employed. As a result, the fiber had a breaking strength of 4.6 GPa, a modulus of 218.1 GPa, and an elongation at break of 2.1%.

The molecular structural formula of the polyimide fiber in this Example was as follow:

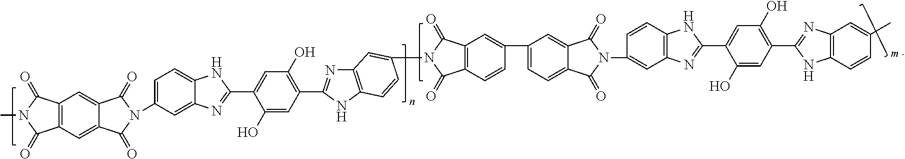

### Example 10

180.20 g (0.750 mol) of 5-amino-2-(2-hydroxyl-5-aminophenyl)benzimidazole and 81.11 g (0.750 mol) of p-phenylenediamine were dissolved in 4,500 ml of N,N-dimethylformamide, 220.67 g (0.75 mol) of 4,4′-biphenyl dianhydride and 163.59 g (0.75 mol) of pyromellitic dianhydride were added with stirring, and reaction was performed at 30° C. for 24 hours to obtain a light yellow viscous polyamic acid spinning solution, which was directly used as a spinning slurry after filtration.

The polyamic acid slurry described above was spun and molded by using a technical scheme of dry-jet wet spinning, and the spinning slurry at normal temperature was precisely metered with a metering pump, extruded from a spinneret orifice, passed through an air layer, and then passed into a coagulating bath of N-methylpyrrolidone and water (in a volume ratio of 1:3). The spinneret had 50 orifices, the orifice size was Φ0.12 mm, the spinning draft ratio was 3.6, the spinning speed was 40 m/min, and the height of the air layer was 5 mm. The primary fiber was washed with water and dried through a hot argon gas channel to obtain a polyamic acid fiber.

The polyamic acid fiber was treated with a gradient heating thermal imidization furnace under an atmosphere of argon gas to obtain a polyimide fiber. The temperature of thermal imidization was increased from 50° C. to 400° C. at a heating rate of 10° C./min. The polyimide fiber obtained was drawn at a drawing ratio of 1.2 under an atmosphere of argon gas at 530° C. to obtain a finished polyimide fiber.

The finished polyimide fiber which was 20 mm and had a modulus of 0.2-0.4% deformation was tested for properties 10 times by using a FAVIMAT tester for linear density, degree of crimp, and tensile strength of single fiber available from Textechno Corporation, Germany, and average values were employed. As a result, the fiber had a breaking strength of 4.3 GPa, a modulus of 165.2 GPa, and an elongation at break of 2.2%.

The molecular structural formula of the polyimide fiber in this Example was as follow:

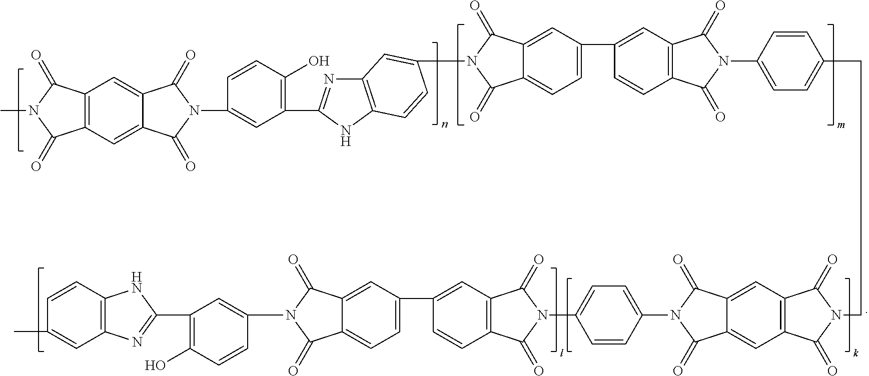

Those described above are merely preferred embodiments of the disclosure. It should be noted that, for the person skilled in the art, various improvements and modifications can also be made without departing from the principle of this invention. These improvements and modifications should be regarded as falling within the protection scope of this invention.

1. A polyimide fiber prepared from a dianhydride compound and a diamine compound, wherein said diamine compound is selected from one or more of:

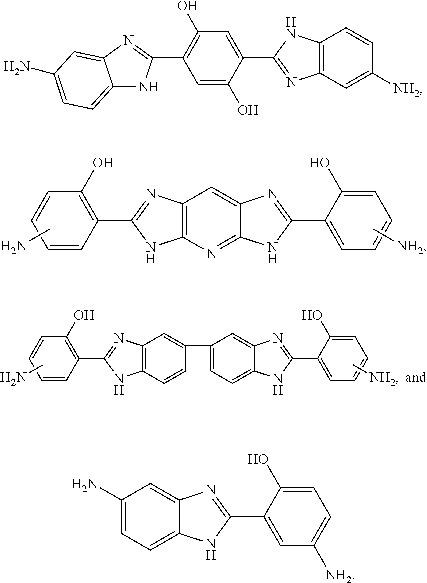

2. The polyimide fiber according to claim 1, wherein said diamine compound further comprises one or more of: 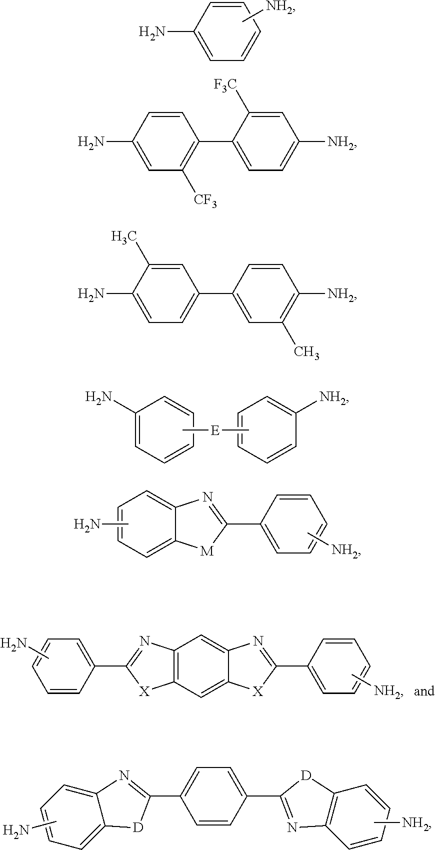
wherein -M- is selected from one or more of —O—, —S—, and —NH—; —X— is selected from one or more of —O—, —S—, and —NH—; -D- is selected from one or more of —O—, —S—, and —NH—; and E is selected from one or more of —O—, —S—, —SO₂—, —CH₂—, —C(CF₃)₂—, —CO—,

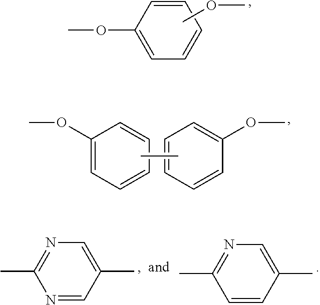

3. The polyimide fiber according to claim 1, wherein said dianhydride compound is selected from one or more of: 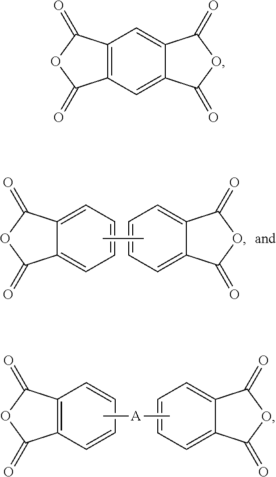
wherein said -A- is selected from —S—, —O—,

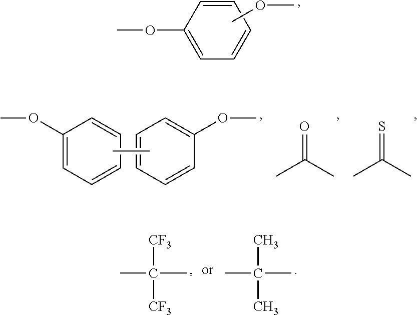

4. The polyimide fiber according to claim 1, wherein the molar ratio of said dianhydride compound to said diamine compound is 1:(0.8-1.2).

5. A preparation method for a polyimide fiber, comprising the steps of:
A) subjecting a dianhydride compound and a diamine compound to a polymerization reaction to obtain a precursor polyamic acid solution; and
B) sequentially subjecting said precursor polyamic acid solution to spinning, imidization, and thermal drawing to obtain a polyimide fiber;
wherein said diamine compound is selected from one or more of:

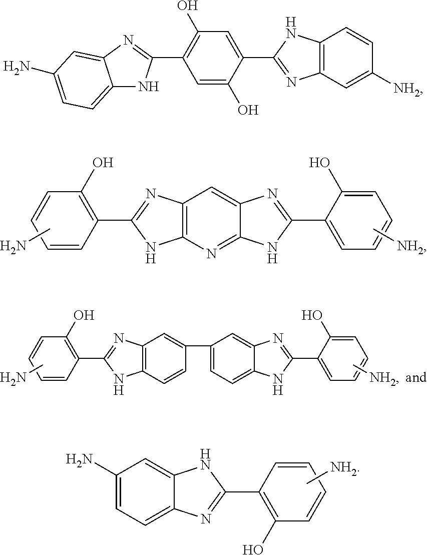

6. The preparation method according to claim 5, wherein said diamine compound further comprises one or more of: 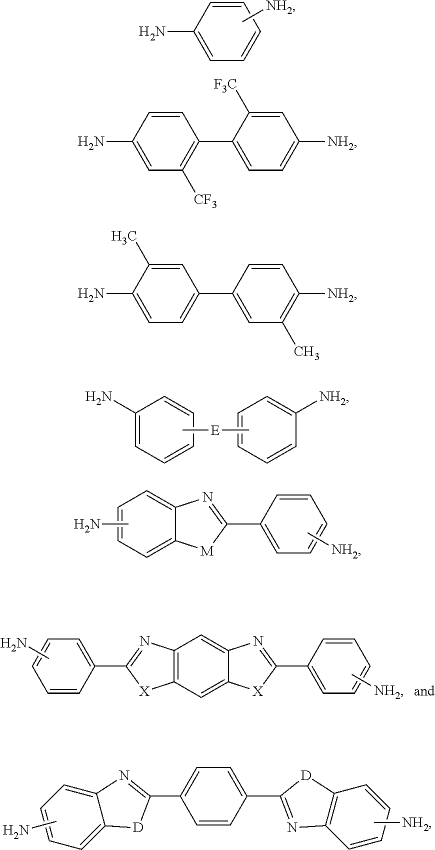
wherein -M- is selected from one or more of —O—, —S—, and —NH—; —X— is selected from one or more of —O—, —S—, and —NH—; -D- is selected from one or more of —O—, —S—, and —NH—; and E is selected from one or more of —O—, —S—, —SO₂—, —CH₂—, —C(CF₃)₂—, —CO—,

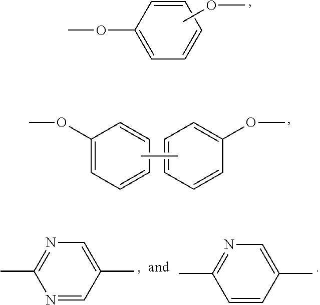

7. The preparation method according to claim 5, wherein said dianhydride compound is selected from one or more of: 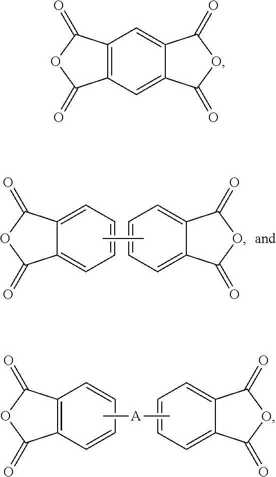
wherein said -A- is selected from —S—, —O—,

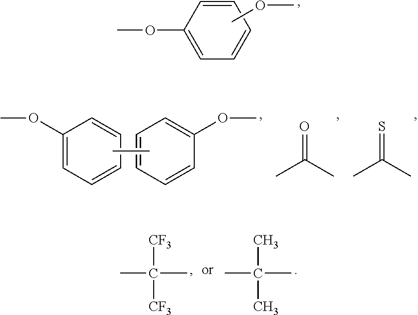

8. The preparation method according to claim 5, wherein the molar ratio of said dianhydride compound to said diamine compound is 1:(0.8-1.2).

9. The preparation method according to claim 5, wherein said spinning is wet spinning, wherein a spinneret for the wet spinning has an orifice size of Φ0.04-Φ0.4 mm and an orifice number of 10-10,000; a spinning draft ratio of the wet spinning is 1.1-6.0; and a speed of the wet spinning is 5-100 m/min.

10. The preparation method according to claim 5, wherein said spinning is dry-jet wet spinning, wherein a spinneret for the dry-jet wet spinning has an orifice size of Φ0.04-Φ0.4 mm and an orifice number of 10-10,000; a spinning draft ratio of the dry-jet wet spinning is 1.1-7.0; and a speed of the dry-jet wet spinning is 5-100 m/min.

11. The preparation method according to claim 5, wherein the temperature for performing said polymerization reaction is in a range from −10° C. to 40° C.

12. The preparation method according to claim 5, wherein said polymerization reaction is performed in an aprotic polar solvent.

13. The preparation method according to claim 12, wherein said aprotic polar solvent is selected from one or more of N,N-dimethylformamide, N,N-dimethylacetamide, dimethyl sulfoxide, and N-methylpyrrolidone.

14. The preparation method according to claim 5, wherein the concentration of said precursor polyamic acid solution is 5 wt %-35 wt %.

15. The polyimide fiber according to claim 1, wherein said polyimide fiber has a structure as shown below: 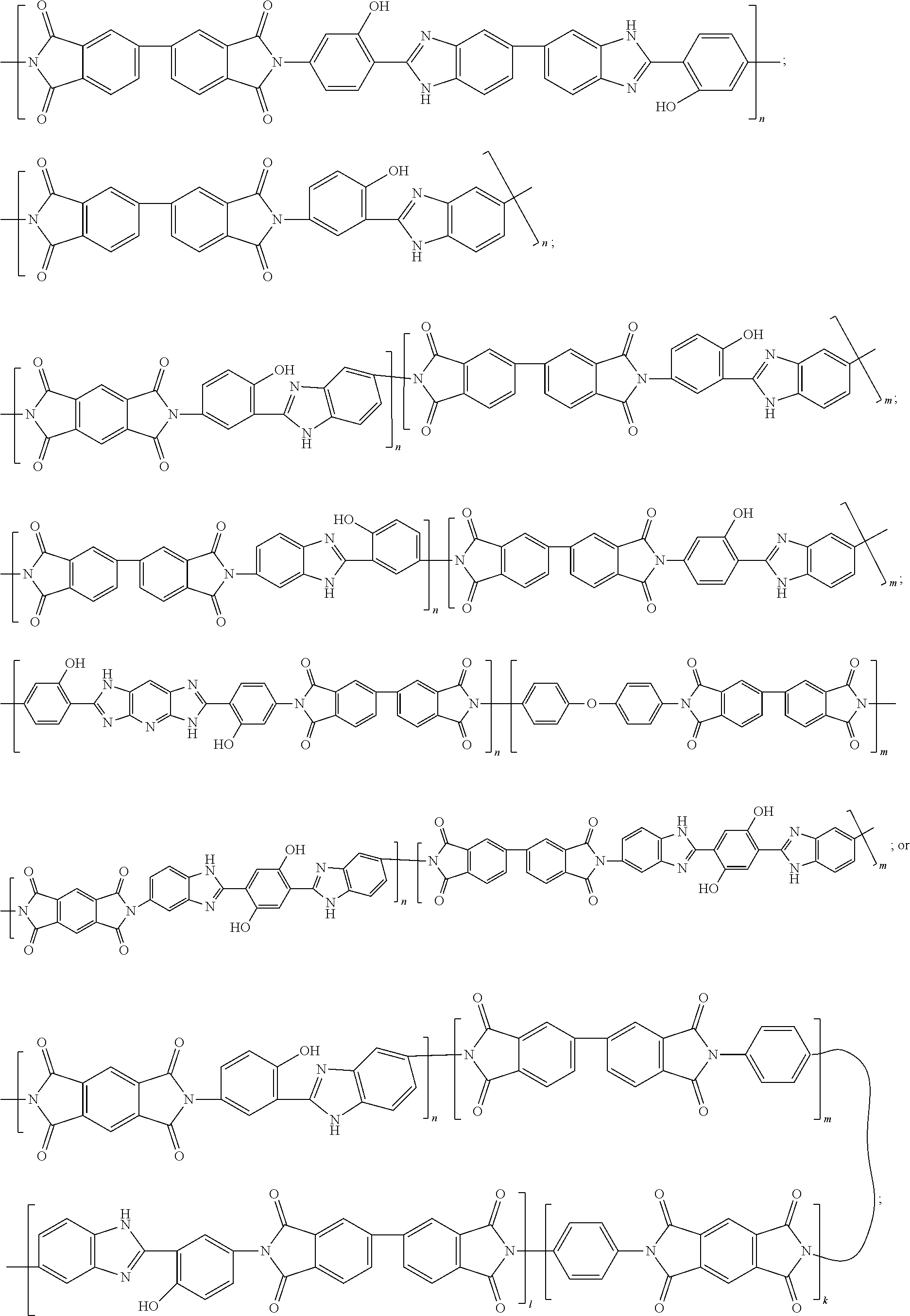
wherein each of n, m, l, and k is a polymerization degree.
